(19) United States
(12) Patent Application Publication
(10) Pub. No.: US 2023/0322014 A1
(43) Pub. Date: Oct. 12, 2023

(54) METHOD FOR GENERATING THREE-DIMENSIONAL ARTWORK

(71) Applicant: Bassett Wood's Studio's LLC, Sandwich, MA (US)

(72) Inventor: James F. Bassett, Tucson, AZ (US)

(73) Assignee: Bassett Wood's Studio's LLC, Sandwich, MA (US)

(21) Appl. No.: 18/295,996

(22) Filed: Apr. 5, 2023

Related U.S. Application Data
(60) Provisional application No. 63/362,678, filed on Apr. 8, 2022.

(51) Int. Cl. B44C 1/28; B44C 3/08; B44C 5/04; A41G 1/02

(52) U.S. Cl. CPC B44C 1/28; B44C 3/085; B44C 5/043; A41G 1/02

(57) ABSTRACT

A method of generating an enhanced visual three-dimensional visual effect to wood sculptures. The includes boiling laminated wood formed into a shape until the plurality of lamination layers physically separate so that the separate lamination layers may be independently pressed. After the separate lamination layers are dried, they can be adhered to each other to reconstitute the formed shape thereby affording the enhanced visual three-dimensional visual effect.

### CROSS-REFERENCE TO RELATED APPLICATION

This application claims the benefit of priority of U.S. provisional application No. 63/362,678 filed Apr. 8, 2022 the contents of which are herein incorporated by reference.

### BACKGROUND OF THE INVENTION

The present invention relates to three-dimensional artwork and, more particularly, to a method of creating such.

Artists are always seeking different mediums for expressing themselves through art. Generated three-dimensional artwork is a favorite of many art lovers. Moreover, present methods for generating three-dimensional art are costly and expensive.

As can be seen, there is a need for a simple and cost-effective method for generating three-dimensional artwork.

### SUMMARY OF THE INVENTION

In one aspect of the present invention, a method of producing three-dimensional artwork, the method including the following: cutting a laminated wood into a shape; sanding the shape with sandpaper; boiling the shape until it separates into layers; pressing the individual layers into a desired effect; drying the layers; gluing the layers into the shape; and painting the shape.

In another aspect of the present invention, a method of producing a three-dimensional wood sculpture, the method includes the following: forming a laminated wood into a shape; boiling the shape until a plurality of laminated layers of the laminated wood physically separate from each other; and adhering the plurality of laminated layers into a replica of the shape in the form of the three-dimensional wood sculpture.

In yet another aspect of the present invention, a three-dimensional visual artistic work includes the following: a first layer of wood; a second layer of wood adhered to the first layer of wood, wherein the first and second layers of wood were physically separated, through a boiling process, from a unitary laminated piece of wood, wherein the laminated piece of wood is formed in a shape prior to the boiling process, wherein the first and second layers are adhered to replicate said shape, wherein the first and second layers have their surfaces smoothed prior to the boiling process, wherein the three-dimensional visual artistic work is painted after said shape is replicated.

These and other features, aspects and advantages of the present invention will become better understood with reference to the following drawings, description, and claims.

### BRIEF DESCRIPTION OF THE DRAWINGS

FIG. 1 is a front elevation view of a plurality of laminates or layers 10 of a single piece of laminated wood cut or otherwise formed in the shape of flower petals, after said piece of laminated wood is subject to boiling so that the plurality of layers is physically separated from said piece of laminated wood, according to an embodiment of the present invention.

FIG. 2 is a perspective view of the plurality of laminates or layers being pressed after being adhered to each other to create a three-dimensional artwork from the physically separated from said piece of laminated wood, according to an embodiment of the present invention.

FIG. 3 is a perspective view of a presser 20 pressing the plurality of laminates or layers. The amount of pressure used to create the flowers in a 3D effect is determined by the amount of depth you are looking for in a particular project (also being very careful as to not split the wood) wherein each flower can come out different.

FIG. 4 is a front elevation view of a three-dimensional artwork according to an embodiment of the present invention.

FIG. 5 is a front elevation view of a three-dimensional artwork according to an embodiment of the present invention.

FIG. 6 is a perspective view of a three-dimensional artwork according to an embodiment of the present invention.

FIG. 7 is a front elevation view of a three-dimensional artwork according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

A general overview of the various features of the invention will be provided, with a detailed description following. Broadly, an embodiment of the present invention provides a method of generating visual art type sculptures comprised of wood, painted, and framed on a decorative wood background to give a visual three-dimensional (3D) effect.

In some embodiments of the present invention, the visual effect may be created by boiling a three-layer multi-laminate wood and separating the wood into three separate sections or pieces. They may then be individually pressed and set to dry for approximately twelve hours. The layers may then be painted and assembled. Skipping or omitting a step may not produce the desired visual effect.

The present invention may form a 3D effect for the shape originally formed prior to boiling. The boiling allows for very thin sections to be assembled (or re-assembled as one would have it) reconstituting the original shape with a 3D-effect for objects.

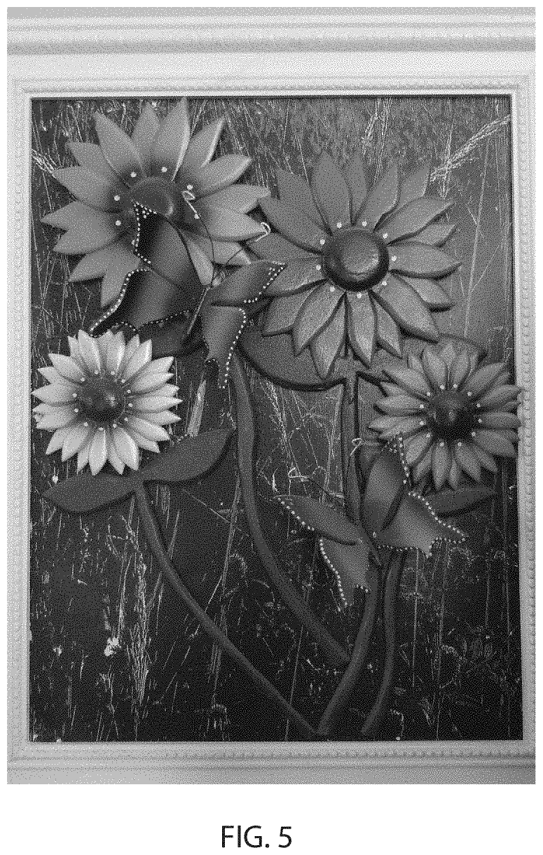

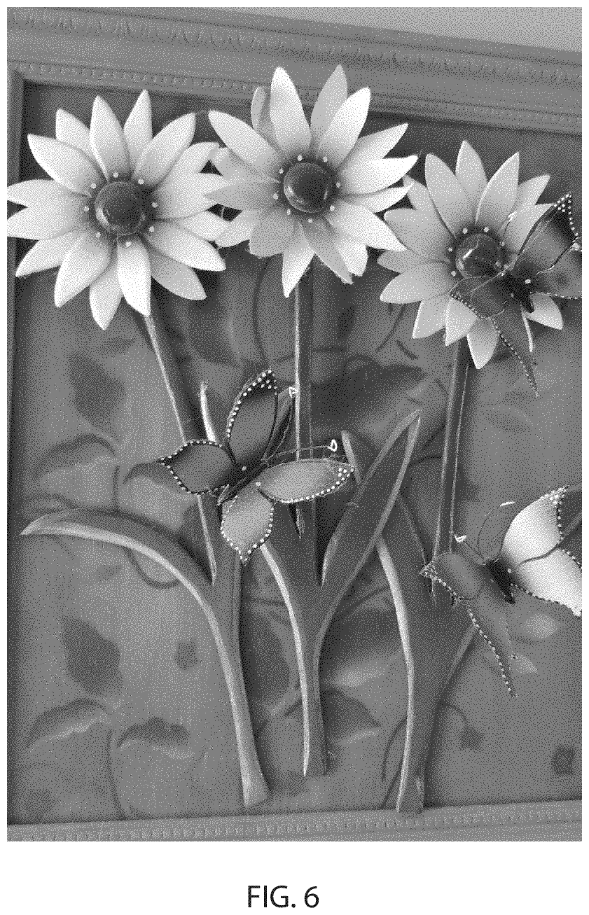

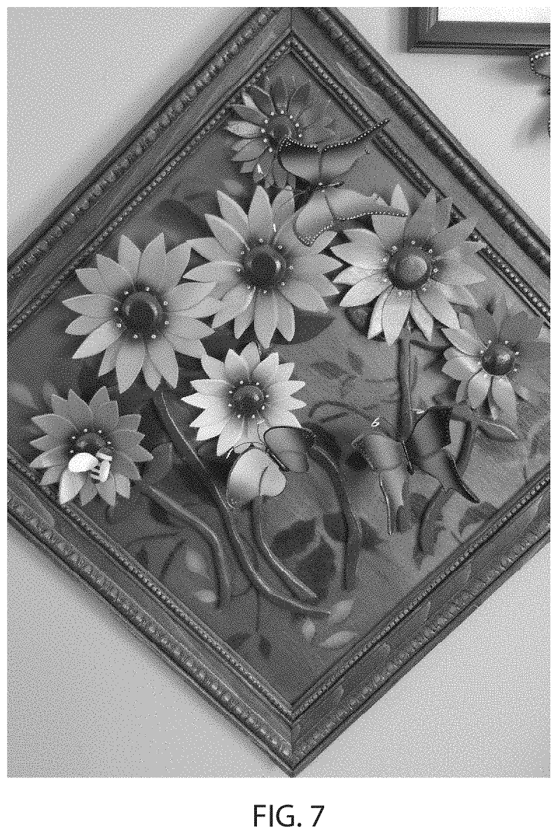

Referring now to FIGS. 5-7 are photographic embodiments of the present invention, better illustrating the three-dimensional effect resulting from the present invention.

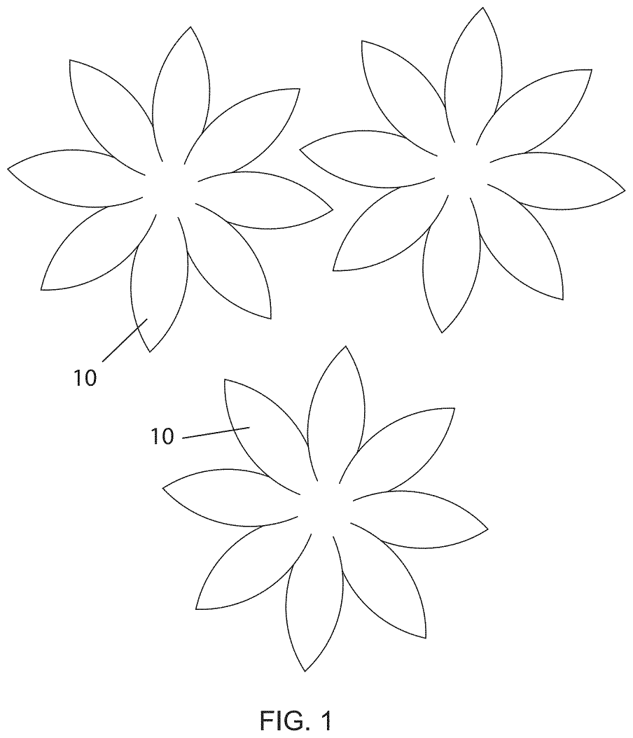

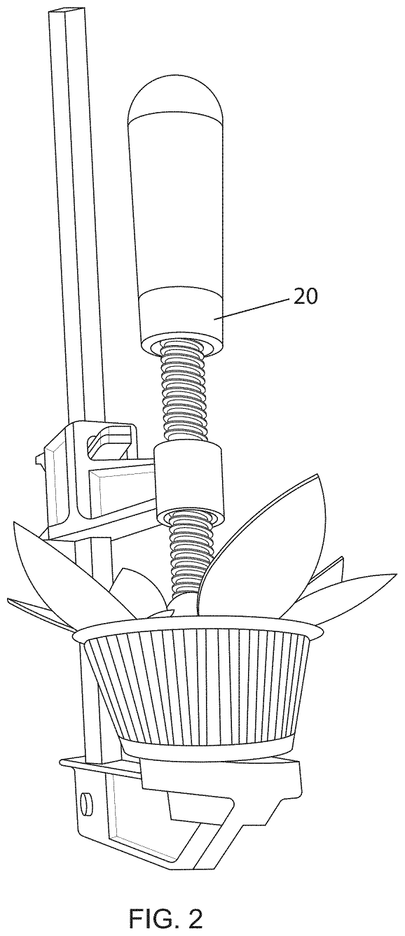

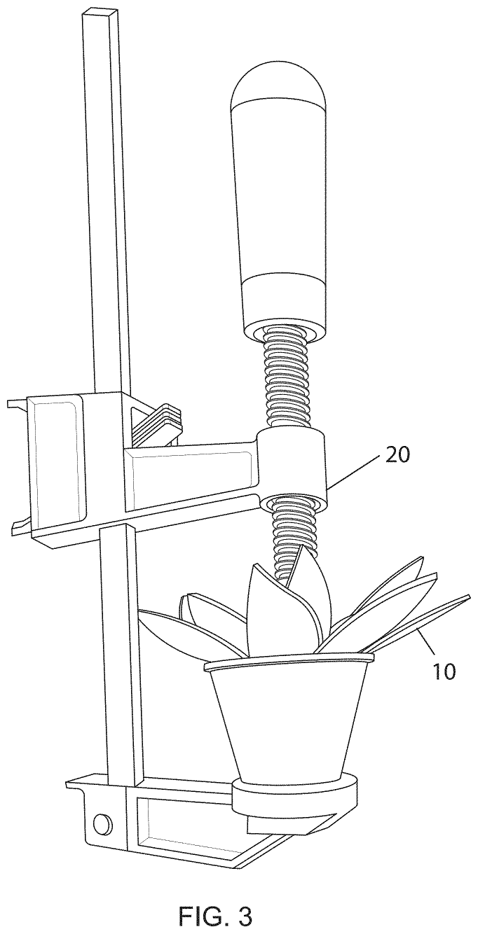

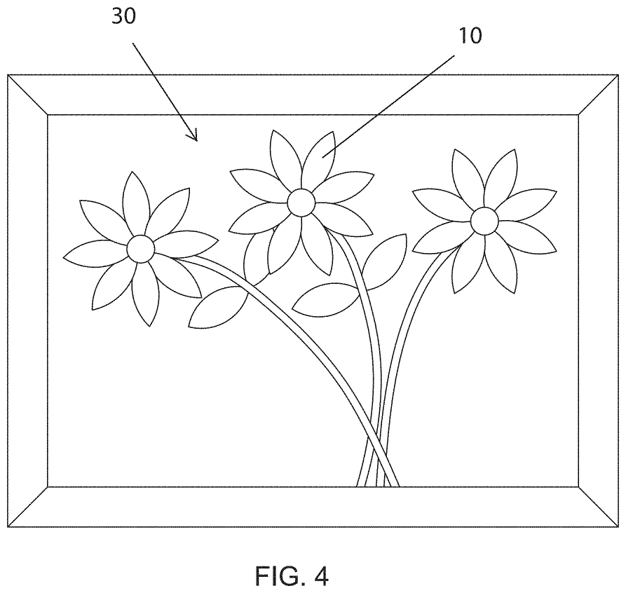

Referring to FIG. 1-4, to illustrate the key components of the present invention. Each embodiment is of wood formed into flowers or butterflies with a 3D effect. It being understood that other shapes may be utilized in this innovating process.

The present invention may include the following method steps: a piece of multi-layered laminated wood may be cut into a shape, such as a butterfly or flower. The shape may be sanded with sandpaper. The shape may be boiled in water for approximately five to ten minutes or until it separates into multiple layers 10 form the single laminated wood piece. The layers 10 may be individually pressed to a desired effect and dried overnight. The layers may be glued together in the shape or to the desired shape. The layers or shape may then be pressed by a presser 20 until the glue dries. A center piece may be added, and the shape and centerpiece may be painted. Thereby a three-dimensional art piece 30 is created.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A method of producing three-dimensional artwork, the method comprising:
forming a laminated wood into a shape;
boiling the shape until a plurality of laminated layers of the laminated wood physically separate from each other; and
adhering the plurality of laminated layers into a replica of the shape.

2. The method of claim 1, further comprising, prior to boiling, sanding the shape with sandpaper.

3. The method of claim 1, further comprising, after boiling, pressing each separated laminate layer into a visual effect.

4. The method of claim 1, further comprising, after boiling, painting the replicated shape.

5. A method of producing a three-dimensional wood sculpture, the method comprising:
forming a laminated wood into a shape;
boiling the shape until a plurality of laminated layers of the laminated wood physically separate from each other; and
adhering the plurality of laminated layers into a replica of the shape in the form of the three-dimensional wood sculpture.

6. A three-dimensional visual artistic work comprising:
a first layer of wood; and
a second layer of wood adhered to the first layer of wood, wherein the first and second layers of wood were physically separated, through a boiling process, from a unitary laminated piece of wood.

7. The three-dimensional visual artistic work of claim 6, wherein the laminated piece of wood is formed in a shape prior to the boiling process.

8. The three-dimensional visual artistic work of claim 7, wherein the first and second layers are adhered to replicate said shape.

9. The three-dimensional visual artistic work of claim 8, wherein the first and second layers have their surfaces smoothed prior to the boiling process.

10. The three-dimensional visual artistic work of claim 9, wherein the three-dimensional visual artistic work is painted after said shape is replicated.
